(19) United States
(12) Patent Application Publication
(10) Pub. No.: US 2005/0229238 A1
(43) Pub. Date: Oct. 13, 2005

(54) Method and device to determine the network environment and configure a network gateway

(76) Inventors: Jeffrey D. Ollis, Harleysville, PA (US); Louis Bifano, Morrisville, PA (US); David Horoschak, Furlong, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/814,743

(22) Filed: Mar. 31, 2004

(51) Int. Cl. H04L 9/00; H04L 9/32; G06F 11/30; G06F 12/14

(52) U.S. Cl. 726/4

(57) ABSTRACT

A method (20, 30, 40) for automatically self-configuring a network device (13, 17) being added to a network (8, 9) without user intervention operates by providing that the network device (13, 17) discover its network environment. The network device (13, 17) attempts to access each of those services it offers from the network (8, 9) to determine if any of these services are already being provided by the network (8, 9). Upon successfully accessing a particular service by the network device (13, 17), the network device disables the particular service within the network device (13, 17); and upon unsuccessfully accessing the particular service by the network device (13, 17), the network device (13, 17) activates the predetermined service within the network device (13, 17). Another technique for self-configuring the network device (13, 17) provides that the network device (13, 17) examine the IP address (or class of addresses) the network device (13, 17) acquires from the network (8, 9). Upon determining that the acquired Internet Protocol address is a private Internet Protocol address, the network device (17) configures itself to use a local area network port (5) to access the Internet (11) and the network (9) without user intervention. Alternatively, upon determining that the assigned Internet Protocol address is not a private Internet Protocol address, the network device (13) configures itself to use another port (6) (e.g., a WAN port) to access the Internet (11) and a LAN port (5) to access the network (9). Both of these configuration methods are performed entirely without user intervention to reduce the amount of setup required by a user.

### FIELD OF THE INVENTION

The present invention relates generally to methods and apparatuses for communicating, and more particularly to a method and apparatus for communicating over a network.

### BACKGROUND

When a network device, such as the MS1000S, is installed in a consumer's home, the consumer must configure the network device to enable or disable services in the network device, such as Network Address Translation (NAT) and Dynamic Host Configuration Protocol (DHCP) Server, depending whether or not there is a device on the home network that already provides this capability or service. Moreover, the method that this network device employs to access the Internet varies depending on whether or not the network device is intended to be the gateway to the Internet for the remainder of the network or whether the network device is intended to be a peer on the network. More specifically, the network device would only use one port (the local area network (LAN) port) to access both the Internet and the home network if another device was providing gateway services, whereas the network device would use a LAN port to access the home network and a Wide Area Network (WAN) port to access the Internet if there is no device on the home network providing gateway services.

Yet configuring network devices can be difficult, especially for consumers with little or no training.

The present invention is therefore directed to the problem of developing a method and apparatus for reducing the configuration required for a home network device.

### SUMMARY OF THE INVENTION

The present invention solves these and other problems by providing that the network device being added to a home network self-configures by discovering whether the network device is the gateway to the Internet for the home network and whether other services are already being provided by the home network.

According to one aspect of the present invention, the network device attempts to use one or more predetermined services, such as DHCP Server services and NAT services. If one or more of these one or more predetermined services are already being provided by another device on the home network, the network device being added disables those one or more predetermined services already being provided by another device on the home network and activates the other services or capabilities if the network device is unsuccessful in accessing these predetermined services.

According to another aspect of the present invention, the network device acquires an IP address from the home network and examines the acquired IP address to determine whether the acquired IP address is a private IP address, such as 192.168.1.5, or whether the acquired IP address is a public IP address. If the acquired IP address is a private IP address, then the network device knows it is not intended to be the gateway to the Internet for the home network, and therefore uses its LAN port to access both the Internet and the home network. If the acquired IP address is a public IP address (or at least not a private IP address), then the network device uses a LAN port to access the network and a WAN port to access the Internet because the network device knows it should act as the gateway for the network.

Other aspects of the invention will be apparent to those of skill in the art upon review of the detailed description in light of the following drawings.

### BRIEF DESCRIPTION OF THE DRAWINGS

FIG. 1 depicts two exemplary embodiments of networks operating in accordance with one aspect of the present invention.

FIG. 2 depicts an exemplary embodiment of a method for configuring a network device upon connection of the network device to an existing network according to another aspect of the present invention.

FIG. 3 depicts another exemplary embodiment of a method for configuring a network device upon connection of the network device to an existing network according to yet another aspect of the present invention.

FIG. 4 depicts another exemplary embodiment of a method for configuring a network device upon coupling of the network device to an existing network according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

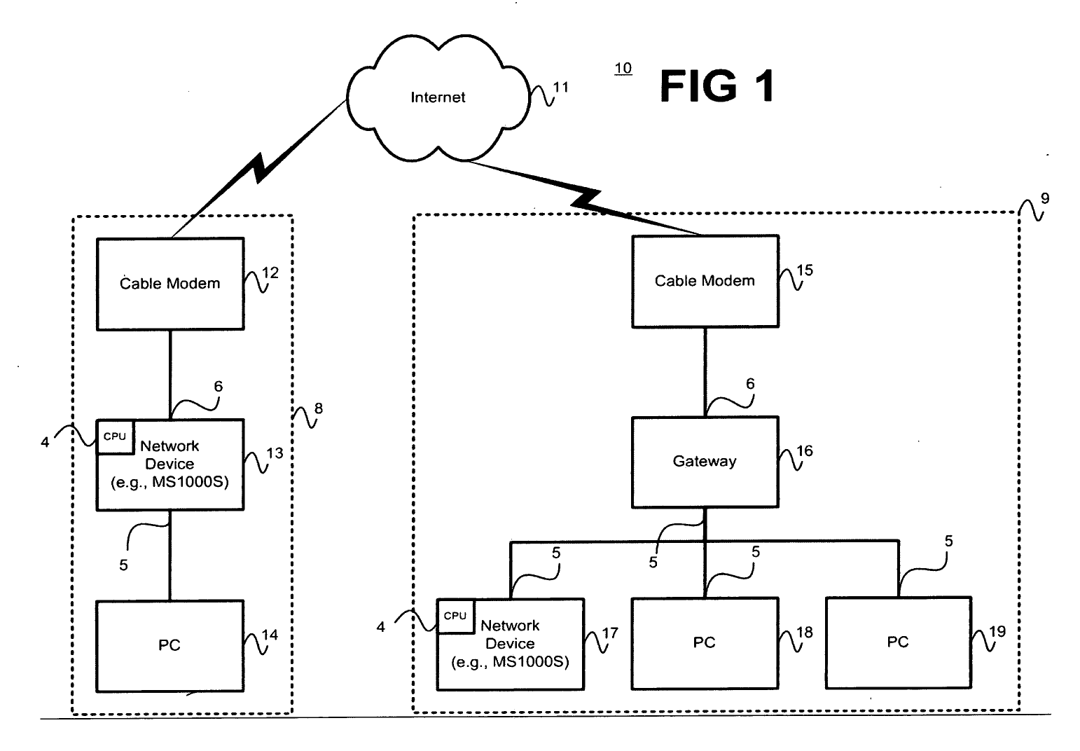

Turning to FIG. 1, upon connecting a network device 13, 17, such as a Motorola Media Station MS1000S, to a home network 8, 9, respectively, or any other network, there are several possible configurations. For example, in one possible network configuration 8 the network device 13 can be expected to act as a gateway to the Internet 11 for another network device or personal computer 14. In another possible network configuration 9, the network device 17 can be expected to access the Internet 11 through an existing gateway 16, e.g., the network device is a peer to other devices or computers on the network. If there already exists a gateway 16, the network device 17 may include services or servers that must be disabled to prevent problems from arising by multiple devices attempting to perform the same types of services for the network. Additional network devices or personal computers 18, 19 may be connected to the same gateway. While only two personal computers are shown for brevity sake, many more are possible. The gateway 13, 16 may then be connected to the Internet 11 through a cable modem 12, 15, respectively, or through another communication device. Many other network configurations are also possible. In network configuration 9, the PCs 18, 19 and the network device 17 use local area network ports 5 to communicate among themselves and to communicate with the gateway 16. The gateway 16 uses a local area network port 5 to communicate with the PCs 18, 19 and the network device 17. The gateway 16 uses a wide area network port 6 to access the Internet via the cable modem 15.

The network device 13, 17 at least includes a central processing unit (CPU) 4, a local area network port 5, and a wide area network port 6. The processor 4 manages data transfer between the ports 5, 6. Upon connection (wirelessly or wired) of one of the ports 5, 6 to the network 8, 9, the CPU 4 will perform one or more of the methods set forth below to determine the role of the network device 13, 17 in the network 8, 9 and then to configure itself accordingly.

Thus, the network device must be informed of its role to properly configure the network device. To do so automatically, the network device can determine its role based on the class of Internet Protocol addresses that the network device receives from the network or from outside the network (or from a user, for example). For example, by noting that the class of Internet Protocol addresses comprises private IP addresses, the network device can then assume that another device is acting as the gateway for the network to which the network device has been recently connected. Once this is determined, the network device can then enable and disable other functions it may perform depending upon whether these functions are performed by a gateway to the Internet or not. One method of determining if the IP address is a private IP address is to compare the format of the IP address received or acquired to the standard format for private IP addresses. Two standards are 192.168.x.x and 10.x.x.x in which case x represents any possible octet. If the first octet is 192 and the second octet is 168, then the device knows this is probably a private IP address. If the first octet is 10, then the network device also knows this is probably a private IP address. The network device can then apply any other known standards for private IP addresses to determine if the address is private or not.

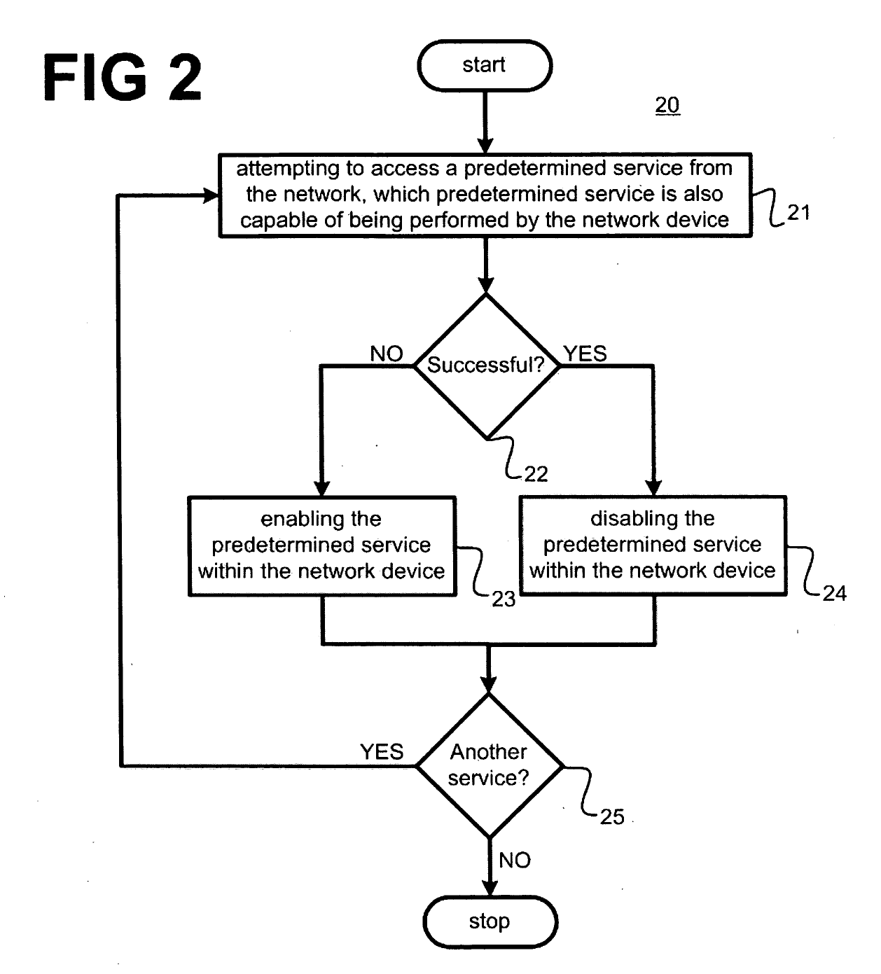

Turning to FIG. 2, shown therein is an exemplary embodiment of a method for configuring a network device upon connection of the network device to an existing network. According to one aspect of the present invention, to determine if another device or devices on the home network (or any network) are already providing any of the services included in the suite of services offered by the network device, the network device being added attempts to access or use each of these services (element 21). If the services are already being provided, then the network device will be able to use them, if not then the network device can then enable these services among those it is capable of offering without user intervention. Thus, upon successfully accessing or using a particular service of the various services offered by the network device (element 22), the network device disables this particular service within its suite of services (element 24). Alternatively, upon unsuccessfully accessing or using a particular service of the various services offered by the network device (element 22), the network device enables or activates this particular service within its suite of services (element 23) under the assumption that the network device is being added to the network to provide this missing service. This feature enables the network device being added to self-configure or self-provision without user intervention. If other services are included within the network device being added, each of the services is tested in a similar manner (element 25) until all of the services have been verified as being present or absent on the existing network. Examples of these services include DNS or NAT or DHCP services.

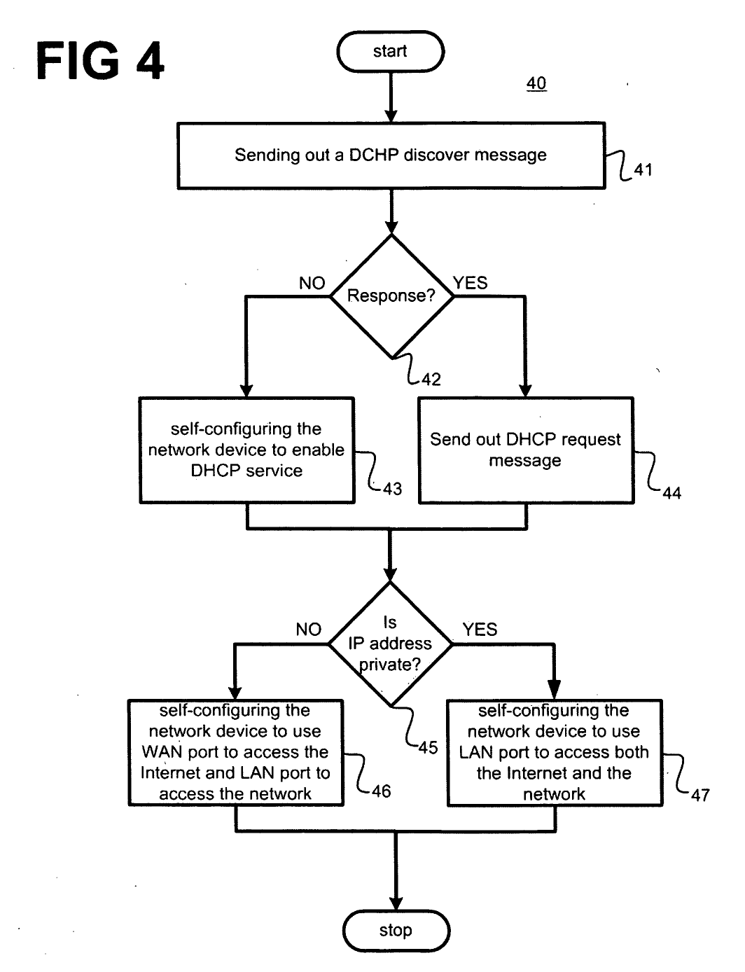

Turning to FIG. 4, shown therein is another exemplary embodiment for automatically configuring a network device. For example, the network device can send out a DHCP discover message to the home network (element 41). If there is no response (element 42), then the network device knows there is no device providing DHCP service and therefore the network device enables DHCP service within itself (element 43). If there is a response (element 42), then the network device requests an IP address by sending a DCHP request message (element 44). Upon receipt of a response to this request message, the network device can examine the received IP addresses to determine if the IP address is private or not (element 45). If the received IP address is not private, then the network device configures itself to use a wide area network to access the Internet because the network device is probably the gateway to the Internet for the network and a local area network port to access the network (element 47). If the received IP address is private, then the network device configures itself to use a local area network port to access both the Internet and the network because some other network device is probably providing this service (element 47).

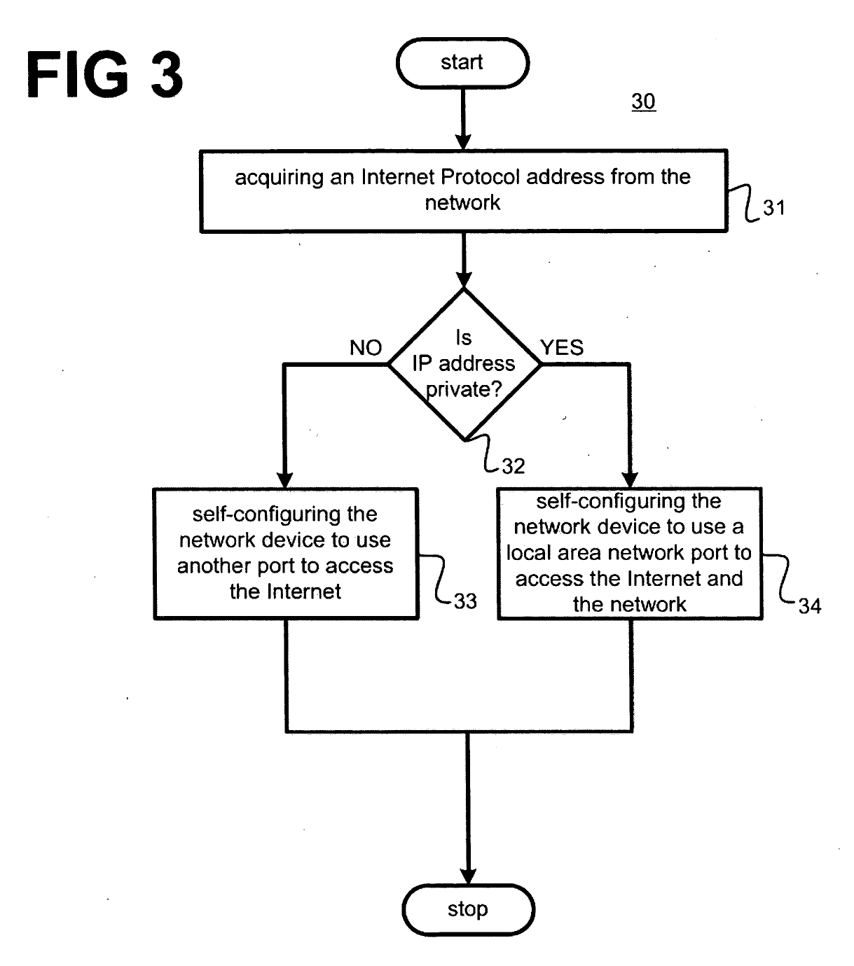

Turning to FIG. 3, shown therein is another exemplary embodiment of a method for configuring a network device upon connection of the network device to an existing network. According to yet another aspect of the present invention, upon connection of the network device to an existing network, the network device acquires an EP address (or a class of IP addresses) from the home network (element 31) and examines the acquired IP address (or class of IP addresses) to determine whether the acquired IP address (or class of IP addresses) is a private IP address (or a class of private IP addresses), such as 192.168.1.5, or whether the acquired IP address (or class of IP addresses) is a public IP address (or class of public IP addresses) (element 32). If the acquired IP address (or class of IP addresses) is a private IP address (or class of private IP addresses) (element 32), then the network device knows it is not intended to be the gateway to the Internet for the home network, and therefore the network device uses its LAN port to access both the Internet and the home network (element 34). If the acquired IP address (or class of IP addresses) is not a private IP address (or class of private IP addresses) (element 32), then the network device knows it is intended to be the gateway to the Internet for the home network, and therefore the network device uses another port different than the network port to access the Internet (element 33).

Various combinations of the above exemplary embodiments can be employed together without departing from the scope of the invention. Moreover, although various embodiments are specifically illustrated and described herein, it will be appreciated that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

1. A method (20) for automatically self-configuring a network device being added to a network comprising:
attempting (21) to access a predetermined service from the network, which predetermined service is also capable of being performed by the network device;
upon (24) successfully accessing the predetermined service by the network device, disabling the predetermined service within the network device; and
upon (23) unsuccessfully accessing the predetermined service by the network device, activating the predetermined service within the network device.

2. The method (20) according to claim 1, wherein the predetermined service includes a network address translation service.

3. The method (20) according to claim 1, wherein the predetermined service includes a dynamic host configuration protocol server.

4. The method (20) according to claim 1, wherein the predetermined service includes DNS service.

5. The method (20) according to claim 1, further comprising:
acquiring (31) an Internet Protocol address from the network;
determining (32) if the Internet Protocol address assigned by the network is a private Internet Protocol address.

6. The method (20) according to claim 5, further comprising:
upon (34) determining that the assigned Internet Protocol address is a private Internet Protocol address, self-configuring the network device to use a local area network port to access the Internet and the network.

7. The method (20) according to claim 5, further comprising:
upon (33) determining that the assigned Internet Protocol address is not a private Internet Protocol address, self-configuring the network device to use a wide area network port to access the Internet and a local area network port to access the network.

8. A method (30) for automatically self-configuring a network device being added to a network comprising:
acquiring (31) an Internet Protocol address from the network;
determining (32) if the Internet Protocol address assigned by the network is a private Internet Protocol address; and
upon (34) determining that the assigned Internet Protocol address is a private Internet Protocol address, self-configuring the network device to use a local area network port to access the Internet and the network.

9. The method (30) according to claim 8, further comprising:
upon (33) determining that the assigned Internet Protocol address is not a private Internet Protocol address, self-configuring the network device to use a wide area network port to access the Internet and a local area network port to access the network.

10. The method (30) according to claim 8, further comprising:
attempting (21) to access a predetermined service from the network, which predetermined service is also capable of being performed by the network device;
upon successfully (24) accessing the predetermined service by the network device, disabling the predetermined service within the network device; and
upon (23) unsuccessfully accessing the predetermined service by the network device, activating the predetermined service within the network device.

11. The method (30) according to claim 8, further comprising:
attempting (21) to access one or more predetermined services from the network, each of which one or more predetermined services is also capable of being performed by the network device;
disabling (24) within the network device each of the one or more predetermined services that were successfully accessed by the network device; and
enabling (23) within the network device each of the one or more predetermined services that were unsuccessfully accessed by the network device.

12. The method (30) according to claim 10, wherein the predetermined service includes a network address translation service.

13. The method (30) according to claim 10, wherein the predetermined service includes a dynamic host configuration protocol server.

14. The method (30) according to claim 10, wherein the predetermined service includes DNS service.

15. A method (30) for automatically self-configuring a network device being added to a network comprising:
acquiring (31) an Internet Protocol address from the network; and
self-configuring (33) the network device to act as a gateway to the Internet for the network based on a format of the Internet Protocol address.

16. The method (30) according to claim 15, wherein the format of the Internet Protocol address includes an address type.

17. The method (30) according to claim 15, wherein the address type includes a public Internet Protocol address.

18. The method (30) according to claim 15, wherein the address type includes a private Internet Protocol address.

19. The method (30) according to claim 15, wherein the address type includes a format that matches 192.168.x.x or 10.x.x.x wherein the numbers constitute octets and the x constitutes any octet.

20. A method (40) for self-configuring a network device comprising:
sending (41) a DHCP discover message to the network upon coupling the network device to a network;
upon (43) receiving no response to the DHCP discover message, enabling DHCP service within the network device;
upon (44) receiving a response to the DHCP discover message, sending a DHCP request for an IP address;
upon (45) receiving a response to the DHCP request message, examining the received IP address to determine if the received IP address is a private IP address or not; and
upon (47) determining that the received IP address is a private IP address, then using a single LAN port to access the network and the Internet; and
upon (46) determining that the received UP address is not a private IP address, then using a LAN port to access the network and a WAN port to access the Internet.

21. An apparatus (13, 17) for coupling to a network comprising:
a local area network port (5);
a wide area network port (6);
a processor (4) to send data to and from the local area network port (5) and the wide area network port (6), said processor (4):
sending (41) a DHCP discover message to the network upon coupling the local area network port (5) to a network;
upon (43) receiving no response to the DHCP discover message, enabling DHCP service;
upon (44) receiving a response to the DHCP discover message, sending a DHCP request for an IP address;
upon (45) receiving a response to the DHCP request message, examining the received IP address to determine if the received IP address is a private IP address or not; and
upon (47) determining that the received IP address is a private IP address, then using the local area network port (5) to access the network and the Internet; and
upon (46) determining that the received UP address is not a private IP address, then using the local area network port (5) to access the network and the wide area network port (6) to access the Internet.
